(19) United States
(12) Patent Application Publication
(10) Pub. No.: US 2011/0199268 A1
(43) Pub. Date: Aug. 18, 2011

(54) ANTENNA APPARATUS FOR RADIO-BASED ELECTRONIC DEVICES

(75) Inventors: Dietmar Gapski, Bocholt (DE); Oliver SPiess, Bocholt (DE)

(73) Assignee: GIGASET COMMUNICATIONS GMBH, Muenchen (DE)

(21) Appl. No.: 12/808,950

(22) PCT Filed: Dec. 1, 2008
(86) PCT No.: PCT/EP08/66504

§ 371 Date: Jul. 7, 2010

(30) Foreign Application Priority Data
Dec. 21, 2007 (DE) 10 2007 062 051.0

(51) Int. Cl. H01Q 1/24

(52) U.S. Cl. 343/702

(57) ABSTRACT

An antenna apparatus is proposed, which can be operated outside in the vicinity around the antenna apparatus despite a shielding effect of an electrically conducting frame or electrically conducting housing. In the process, the electrically conducting frame or electrically conducting housing encloses a housing volume inside the housing, within said volume an electrically conducting connection being produced from a first to a second location of the electrically conducting frame or the electrically conducting housing. The first and the second locations are selected such that a radio resonance chamber is separated by a parallel radio resonance at a working frequency of the electronic device inside the enclosed housing volume by means of the electrically conducting connection.

### CROSS-REFERENCE TO RELATED APPLICATIONS

This application is a National Stage of International Application PCT/EP2008/066504, filed Dec. 1, 2008. This application claims benefit and priority of German application 10 2007 062 051.0 filed Dec. 21, 2007. The entire disclosures of the above applications are incorporated herein by reference.

### BACKGROUND

This section provides background information related to the present disclosure which is not necessarily prior art.

1. Technical Field

The invention relates to an antenna apparatus.

2. Discussion

It is known to manufacture the housings of wireless electronic devices, for example mobile communication terminals or communication terminals which are to be used in a mobile capacity, as a plastic part.

When metal-coated or metallic housings, or housings which are at least partially metal-coated or metallic, are used, the problem arises that an antenna apparatus which is placed inside the housing experiences a shielding effect.

### SUMMARY OF THE INVENTION

An object of the present invention is to provide an antenna apparatus of the aforementioned type which is functional in the vicinity outside the antenna apparatus despite a shielding effect of an electrically conductive frame or an electrically conductive housing.

Accordingly, it is preferable for a housing to have a lateral surface which includes at least one section that is metal-coated or metallic and which encloses an inner volume of the housing. An electrically conductive connection from a first to a second location of the respective metal-coated or metallic lateral surface is established within the enclosed housing volume. The first and second locations are selected in such a way that a wireless resonance chamber is partitioned inside the enclosed housing volume as a result of the electrically conductive connection between the first and the second location, the wireless resonance chamber having a wireless parallel radio resonance which is matched to a working frequency of a basic electronic device.

Such an antenna apparatus has the advantage that it may be used even when, or specifically because, the lateral surface of the housing of an affected wireless electronic device has an at least partially metal-coated or metallic design.

Accordingly, the partitioned resonance chamber between the above-referenced first and second locations has a wireless path length which is adjusted to one-half the wavelength of the working frequency of the basic wireless electronic device.

This adjustment is important for obtaining the desired parallel resonance in the affected resonance chamber.

The high-frequency energy to be emitted or received via the antenna apparatus may advantageously be respectively injected into or extracted from the referenced partitioned resonance chamber using customary galvanic, inductive, or capacitive techniques.

The electrically conductive connection between the first and the second location may advantageously be easily achieved using a conductor provided specifically for this purpose, or by means of an electrically conductive surface of a printed circuit board.

In addition, it is also advantageous that the antenna apparatus may be manufactured as a component of a wireless electronic device which is a wireless communication terminal.

Lastly, wireless electronic devices with completely new designs may be produced using the antenna apparatus.

### BRIEF DESCRIPTION OF THE DRAWINGS

The drawings described herein are for illustrative purposes only of selected embodiments and not all possible implementations, and are not intended to limit the scope of the present disclosure.

The invention is explained in greater detail below with reference to the figures, which show the following:

FIG. 1 shows a first exemplary embodiment of the invention in a schematic, three-dimensional illustration;

FIG. 2 shows a second exemplary embodiment of the invention in a schematic, three-dimensional illustration;

FIG. 3 shows a first attachment example for an antenna cable for an article according to FIG. 1,

FIG. 4 shows a second attachment example for an antenna cable for an article according to FIG. 1; and

FIG. 5 shows a third attachment example for an antenna cable for an article according to FIG. 1.

Corresponding reference numbers indicate corresponding parts throughout the several views of the drawings.

### DETAILED DESCRIPTION OF THE PREFERRED EMBODIMENTS

Example embodiments will now be described more fully with reference to the accompanying drawings.

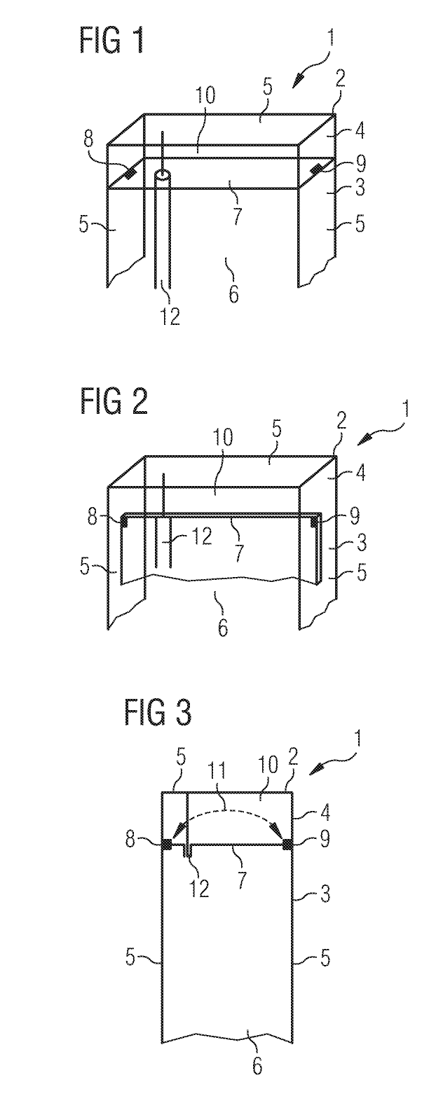

FIGS. 1 through 5 each show a wireless electronic communication terminal 1, with a view of the interior of the communication terminal 1 with regard to the invention.

In all the illustrations according to FIGS. 1 through 5, the communication terminal 1 has a housing 2 which includes a lateral surface 3 that is metallic or metal-coated at least in one section 4. However, in each of the present exemplary embodiments according to FIGS. 1 through 5 the entire lateral surface 3 of the housing 2 is shown as being metallic or metal-coated.

If a metal coating is present, this metal coating may be achieved by chrome plating, for example. If a metallic design is present, the affected section or partial section of the housing 2 is designed as solid metal, for example a metal die-cast part.

The metal-coated or solid metal housing 2 forms an electrically conductive frame 5 which encloses an inner housing volume 6 of the device 1.

Inside the enclosed housing volume 6, an electrically conductive connection 7 is established through the enclosed housing volume 6, from a first to a second location 8, 9 on the respective metal-coated or metallic lateral surface 3.

The referenced first and second locations 8, 9 are both selected in such a way that within the enclosed housing volume 6, a wireless resonance chamber 10 having a wireless parallel resonance at a working frequency of the electronic device 1 is partitioned as a result of the electrically conductive connection 7.

For this purpose, the partitioned resonance chamber 10 between the first and the second location 8, 9 has a wireless path length 11 (shown only in FIGS. 3 through 5 for simplicity) which corresponds to one-half the wavelength of the working frequency of the device 1.

Each of FIGS. 1 through 5 schematically shows an attachment of an antenna cable 12 with regard to the respective partitioned resonance chamber 10.

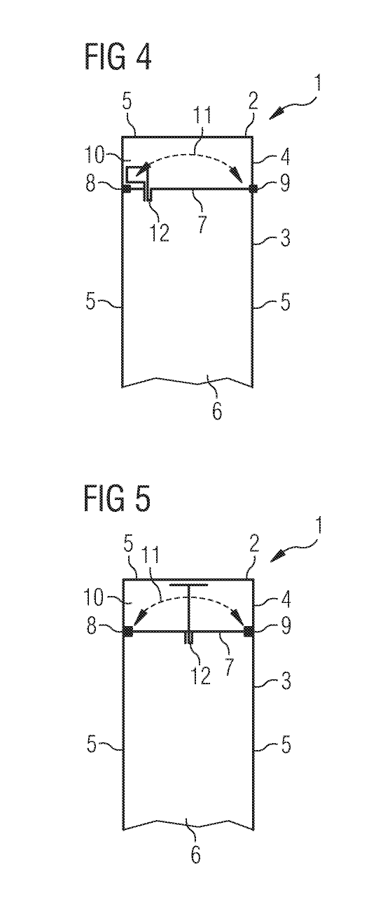

In particular, FIG. 3 shows an attachment option of a galvanic type, FIG. 4 shows an attachment option of an inductive type, and FIG. 5 shows an attachment option of a capacitive type.

The electrically conductive connection 7 between the referenced first and second locations 8, 9 may be achieved using a conductor designed specifically for this purpose (FIGS. 1 and 3 through 5), or by means of an electrically conductive surface (FIG. 2) of a printed circuit board 13.

The surface in question may, for example, be a copper layer of the printed circuit board 13.

The specialized conductor may be a wire or strip.

With the aid of the referenced attachment options for antenna cable 12, by using the antenna apparatus which is specially formed using the above-described measures it is possible for high-frequency energy which is to be emitted to be injected into, or high-frequency energy which is to be received to be extracted from, the partitioned resonance chamber (10) by use of galvanic, inductive, or capacitive means.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1-6. (canceled)

7. A wireless communication terminal comprising:
housing frame;
a printed circuit board;
wireless resonance chamber,
the housing frame having an electrically conductive design at least in one section,
the wireless resonance chamber being delimited by a section having an electrically conductive design and by an electrically conductive connection,
the wireless resonance chamber being a conductor-free space in which an electromagnetic radio wave may be formed in such a way that parallel resonance is formed at a working frequency of the electronic device, and
the section of the housing frame having an electrically conductive design has a shielding effect on the wireless resonance chamber,
wherein the section which delimits a portion of the wireless resonance chamber is at least a subsection of the frame section having an electrically conductive design,
wherein the electrically conductive connection which delimits the wireless resonance chamber is an electrically conductive surface of the printed circuit board,
wherein the electrically conductive connection makes electrically conductive contact at two locations with the section having an electrically conductive design thereby enclosing the resonance chamber, and
wherein the high-frequency energy to be emitted by the wireless resonance chamber may be extracted from the region to be shielded, or the high-frequency energy to be received in the wireless resonance chamber may be injected into the region to be shielded, by attaching an antenna cable.

8. The antenna assembly according to claim 7, wherein the wireless resonance chamber has a radio wavelength between the oppositely situated contact surfaces which is adjusted to one-half the wavelength of the working frequency of the device.

9. The antenna assembly according to claim 7, wherein an antenna cable is attached to the wireless resonance chamber in such a way that the high-frequency energy to be emitted or supplied is respectively injected or extracted by use of galvanic, inductive, or capacitive means.

10. The antenna assembly according to claim 7, wherein the electrically conductive section of the housing frame has a metallic or metal-coated design.

11. The antenna assembly according to claim 7, wherein the housing frame has a metallic or metal-coated design.

12. The antenna assembly according to claim 7, wherein the housing frame completely or almost completely encloses the wireless electronic device.

13. A wireless communication terminal comprising:
housing frame;
a printed circuit board;
wireless resonance chamber,
the housing frame having an electrically section,
the wireless resonance chamber being defined by a section having an electrically conductive design and by an electrically conductive connection,
the wireless resonance chamber being a conductor-free space in which an electromagnetic radio wave may be formed in such a way that parallel resonance is formed at a working frequency of the electronic device, and
the electrically conductive section of the housing frame having a shielding effect on the wireless resonance chamber,
wherein the section which delimits a portion of the wireless resonance chamber is at least a subsection of the frame section having an electrically conductive design,
wherein the electrically conductive connection which delimits the wireless resonance chamber is an electrically conductive surface of the printed circuit board,
wherein the electrically conductive connection makes electrically conductive contact at two locations with the electrically conductive section thereby enclosing the resonance chamber, and
wherein high-frequency energy to be emitted by the wireless resonance chamber may be extracted from the region to be shielded, or the high-frequency energy to be received in the wireless resonance chamber may be injected into the region to be shielded, by attaching an antenna cable.
